(19) United States
(12) Patent Application Publication
(10) Pub. No.: US 2026/0170054 A1
(43) Pub. Date: Jun. 18, 2026

(54) MULTIMODAL DATA PROCESSING FOR CONTENT RETRIEVAL SYSTEMS AND APPLICATIONS

(71) Applicant: NIVIDIA Corporation, Santa Clara, CA (US)

(72) Inventors: Tanay Varshney, San Jose, CA (US); Annie Surla, San Jose, CA (US); Davide Marco Onofrio, San Francisco, CA (US)

(21) Appl. No.: 19/266,518

(22) Filed: Jul. 11, 2025

Related U.S. Application Data
(60) Provisional application No. 63/734,067, filed on Dec. 14, 2024.

(51) Int. Cl. G06F 16/73; G06F 40/40; G06V 10/74; G06V 20/40

(52) U.S. Cl. CPC G06F 16/73; G06V 10/761; G06V 20/46; G06V 20/48; G06F 40/40

(57) ABSTRACT

In various examples, multimodal data processing for content retrieval systems and applications is described herein. Systems and methods described herein may convert different modalities of data into a common type of modality. For instance, content data representing a video may be separated into audio data representing sound corresponding to the video—such as speech—along with video data representing frames of the video. The audio data may then be processed using one or more models to generate first text corresponding to a transcript of the speech. Additionally, the video data may be processed to identify specific keyframes that provide important information associated with the video. The keyframes may then be processed using one or more models to generate second text describing the keyframes. The systems and methods may then combine the text from the different modalities and generate data for storage in one or more databases.

### CROSS-REFERENCE TO RELATED APPLICATIONS

This application claims the benefit of U.S. Provisional Application No. 63/734,067, filed on Dec. 14, 2024, the contents of which are hereby incorporated by reference in their entirety.

### BACKGROUND

Content retrieval systems—such as retrieval-augmented generation (RAG) systems—may be used for a variety of purposes. For instance, a content retrieval system may capture information from one or more external knowledge sources for indexing in one or more databases. The content retrieval system may then use the indexed information to augment queries from users with additional information that one or more models—such as one or more language models—may process when performing a task. However, building specific types of content retrieval systems—such as multimodal RAG systems—may be challenging. For example, it may be challenging to capture and index information across multiple modalities, such as text, images, tables, audio, video, and/or any other type of content. As such, various approaches have been developed to build multimodal content retrieval systems.

For instance, a first approach may use a common embedding space such that representations of information stored across different modalities are projected into the same embedding space. For example, a content retrieval system may use a model that includes both an image encoder and a text encoder such that the model is able to generate image embeddings and text embeddings within the same embedding space, where the embeddings are then stored in a database for further processing. However, for this first approach, it may be difficult to tune a model that is able to process multiple modalities. For example, the model may be accurate when matching natural images to text descriptions, but the model may be less accurate when encoding only text and/or synthetic images. While finetuning is an option to improve the model performance, creating a single model that encodes all forms of information is a hard task to perform.

Additionally, a second approach may use brute force to make a specific modality the native search and query for all pipelines associated with different modalities of data. For example, a content retrieval system may use different pipelines to generate embeddings for the various modalities of information used by the content retrieval system—such as a first pipeline for text and a second pipeline for images—where each of the pipelines needs to be searched when processing a query. However, this may massively increase the number of tokens that a model—such as a language model—needs to ingest when processing a query, which may also increase the amount of processing resources required. Additionally, the model needs to be able to ingest information across the multiple modalities. In other words, this second approach simply moves the problem of processing multiple modalities of information from the retrieval phase to the generation phase.

### SUMMARY

Embodiments of the present disclosure relate to multimodal data processing for content retrieval systems and applications. Systems and methods described herein may convert different modalities of data into a common type of modality. For instance, content data representing a video may be separated into audio data representing sound corresponding to the video—such as speech—along with video data representing frames of the video. The audio data may then be processed using one or more models—such as one or more automatic speech recognition (ASR) models (and/or any other type of model)—to generate first text corresponding to a transcript of the speech. Additionally, the video data may be processed to identify specific keyframes—such as by using downsampling, scene detection, key clip detection, and/or frame selection—that may provide important information associated with the video. The keyframes may then be processed using one or more models—such as one or more vision language models (VLM(s)) (and/or any other type of model)—to generate second text describing the keyframes. The systems and methods may then combine the text from the different modalities and generate one or more embeddings corresponding to the combined text for storage in one or more databases, where the stored embedding(s) may later be used to perform one or more tasks.

In contrast to conventional systems, such as the conventional systems that perform the first approach, the systems of the present disclosure, in some embodiments, convert the different modalities of information into a common type of modality of information—such as text—for further processing. This way, the systems of the present disclosure are able to use a model that is trained to encode the single modality of data rather than a model that includes multiple encoders to encode different modalities of data, which may increase the overall accuracy of the systems of the present disclosure and/or may not require any finetuning of the model. Additionally, in contrast to conventional systems, such as the conventional systems that perform the second approach, the systems of the present disclosure, in some embodiments, may only use a single processing pipeline to generate embeddings associated with a single modality of information rather than using multiple processing pipelines to generate different types of embeddings for different modalities of information. This may reduce the amount of computing resources needed to capture and index the information. Additionally, this may reduce the amount of data that is processed by one or more other models using the indexed information.

Furthermore, in contrast to conventional systems, the systems of the present disclosure, in some embodiments, may perform one or more operations to reduce the amount of data that is captured and/or indexed. For instance, the systems of the present disclosure may perform one or more of the processes described herein—such as downsampling, scene detection, key clip detection, and/or frame selection—to identify a portion of the frames of a video that may contain important information for capturing and/or indexing. This may again reduce the amount of computing resources needed for a content retrieval system and/or may improve the content retrieval system by capturing and/or indexing important information without additional information that is of less importance for performing tasks.

### BRIEF DESCRIPTION OF THE DRAWINGS

The present systems and methods for multimodal data processing for content retrieval systems and applications are described in detail below with reference to the attached drawing figures, wherein:

FIG. 1 illustrates an example of a data flow diagram for a process of using multimodal processing in a content retrieval system, in accordance with some embodiments of the present disclosure;

FIG. 2 illustrates an example of performing downsampling on a video in order to reduce a number of frames, in accordance with some embodiments of the present disclosure;

FIG. 3 illustrates an example of performing scene detection to identify one or more chapters associated with a video, in accordance with some embodiments of the present disclosure;

FIGS. 4A-4B illustrate an example of performing clip detection to identify one or more video clips in a chapter of a video, in accordance with some embodiments of the present disclosure;

FIG. 5 illustrates an example of performing frame selection to select frames from a video clip of a video, in accordance with some embodiments of the present disclosure;

FIGS. 6A-6C illustrate examples of blending video text with audio text in order to generate final text associated with a video, in accordance with some embodiments of the present disclosure;

FIG. 7 illustrates an example of generating and storing final text associated with a video in one or more databases, in accordance with some embodiments of the present disclosure;

FIG. 8 illustrates an example of one or more information retrieval systems that use stored data associated with one or more videos to provide information related to queries, in accordance with some embodiments of the present disclosure;

FIG. 9 illustrates a flow diagram showing a method for processing multimodal data to generate information related to a video for storage, in accordance with some embodiments of the present disclosure;

FIG. 10 illustrates a flow diagram showing a method for processing multimodal data to store information related to a video, in accordance with some embodiments of the present disclosure;

FIG. 11A is a block diagram of an example generative language model system suitable for use in implementing at least some embodiments of the present disclosure;

FIG. 11B is a block diagram of an example generative language model that includes a transformer encoder-decoder suitable for use in implementing at least some embodiments of the present disclosure;

FIG. 11C is a block diagram of an example generative language model that includes a decoder-only transformer architecture suitable for use in implementing at least some embodiments of the present disclosure;

FIG. 12 is a block diagram of an example computing device suitable for use in implementing at least some embodiments of the present disclosure; and

FIG. 13 is a block diagram of an example data center suitable for use in implementing at least some embodiments of the present disclosure.

### DETAILED DESCRIPTION

Systems and methods are disclosed related to multimodal data processing for content retrieval systems and applications. For instance, a system(s) may receive content data representing a video that is to be captured and indexed for information retrieval. As described herein, in some examples, the video may include a specific type of video, such as a structured video where the frames include a defined structure or pattern, an unstructured video where the frames have no innate structure and/or pattern, and/or any other type of video that is between a structured video and an unstructured video. For example, the video may include a structured video such as a recorded lecture, a recorded meeting, a keynote presentation, an educational presentation, and/or any other type of tutorial where the frames of the video may be individually understood without relying on the sequence of frames for understanding. The system(s) may then separate the content data into different modalities of data, such as audio data representing sound corresponding to the video along with video data representing the frames of the video.

The system(s) may then process the audio data using one or more models—such as one or more automatic speech recognition (ASR) models, one or more natural language understanding (NLU) models, and/or any other type of model—that are configured to generate text (referred to, in some examples, as “audio text”) corresponding to at least a transcript of speech represented by the audio data. For example, if the video includes a presentation by a speaker, then the audio text may represent a transcript of the speech from the speaker during at least a portion of the video. Additionally, in some examples, the system(s) and/or the model(s) may associate the audio text with additional information, such as timestamps indicating when individual portions of the audio text occur within the video. As described herein, a portion of the audio text may include, but is not limited to, one or more characters, words, sentences, paragraphs, and/or any other portion of text.

The system(s) may also process the video data using one or more models—such as one or more vision language models (VLM(s)) and/or any other type of model—that are configured to generate text (referred to, in some examples, as “video text”) corresponding to one or more frames of the video. For example, the video text may describe text that is depicted by the frame(s), one or more objects depicted by the frame(s), one or more actions depicted by the frame(s), and/or any other characteristics and/or attributes associated with the frame(s). Additionally, in some examples, the system(s) and/or the model(s) may associate the video text with additional information, such as timestamps indicating locations of respective frames within the video for which individual portions of the video text describe. As described herein, a portion of the video text may include, but is not limited to, one or more characters, words, sentences, paragraphs, and/or any other portion of text.

As described herein, in some examples, the system(s) may perform one or more processes to reduce the number of frames that are processed to generate the video text, such as by identifying frames that represent important information associated with the video. For instance, in some examples, the system(s) may initially process the video data using one or more downsampling techniques in order to reduce the number of frames represented by the video data. In some examples, the system(s) is be able to perform the downsampling based on the type of video—such as the video including a structured video—where many of the frames represent the same information. Additionally, the system(s) may perform the downsampling of the video data using a specific framerate. For instance, if the video data is captured using a first framerate—such as 60 frames per second (FPS) (and/or any other framerate)—then the downsampling may reduce the first framerate to a second, lower framerate (e.g., 4 FPS). The output from the downsampling may be referred to as “sampled video data” that represents the reduced number of frames of the video.

In some examples, the system(s) may then process the sampled video data using one or more scene detection techniques in order to identify one or more chapters (e.g., one or more scenes) associated with the video. As described herein, the system(s) may identify the chapter(s) to create a local context to judge information that is present in the frames. Additionally, in some examples, the system(s) may use one or more computer vision techniques that leverage patterns in a changing color space between frames, one or more detection models that detect the changing patterns, and/or any other type of scene detection technique to identify the chapter(s) of the video. For instance, in some examples, the system(s) may process the sampled video data to identify visual cues such as cuts, fades, dissolves, and/or the like between frames that may indicate a scene transition. The output from the scene detection may then be referred to as “scene video data” that represents the chapter(s) of the video.

In some examples, the system(s) may also process the scene video data using one or more clip detection techniques in order to identify one or more video clips within the chapter(s) of the video. As described herein, the system(s) may identify the video clips(s) to identify frames that are perceptually unique and/or are capturing some unique activity within the video. Additionally, the system(s) may use any technique that identifies differences in consecutive frames—such as pixel characteristic differences, embedding differences, structural differences, and/or the like—to perform the clip detection.

For instance, and for a chapter of the video, the system(s) may process the scene video data representing the frames associated with the chapter to determine similarity scores across consecutive frames. In some examples, and as described in more detail herein, the similarity scores may be determined based on pixel characteristic differences, embedding differences, structural differences, and/or any other types of differences associated with the consecutive frames. The system(s) may then identify locations within the chapter where the similarity scores satisfy one or more threshold scores. As described herein, a threshold score may include, but is not limited to, a mean score of the chapter, a standard deviation from the mean score of the chapter, a mode score of the chapter, a median score of the chapter, and/or any other score. Additionally, the system(s) may use the locations within the chapter to identify one or more video clips associated with the chapter. For example, the system(s) may identify a video clip as starting at a frame that satisfies a threshold score and ending at another frame that no longer satisfies the threshold score and/or another threshold score. The system(s) may then perform similar processes to identify one or more additional video clips associated with the chapter and/or one or more additional chapters. Additionally, the output from the clip detection may then be referred to as “clip video data” that represents the video clip(s) of the video.

The system(s) may then process the clip video data using one or more frame selection techniques in order to identify one or more frames within the video clip(s). For instance, and for a video clip, the system(s) may remove one or more frames that include low quality (e.g., frames that are blurred, etc.), one or more duplicate frames (e.g., depict the same content), and/or any other type of frame that may not include important information. The system(s) may then select one or more frames that may include important information, such as the beginning frame of the video clip, the ending frame of the video clip, one or more frames that include a high entropy (e.g., that include an entropy above a threshold), and/or any other frame. Additionally, the system(s) may then perform similar processes to select one or more additional frames from one or more additional video clips associated with the video. The output from the frame selection may then be referred to as “selected video data” that represents the selected frame(s) of the video. Additionally, the system(s) may then generate the video text using the selected frame(s).

After generating the audio text and the video text, in some examples, the system(s) may then combine the audio text with the video text to generate final text associated with the video using one or more techniques. For instance, in some examples, the system(s) may use the timestamps associated with the audio text and the timestamps associated with the video text to input portions of the video text into the audio text in chronological order to generate the final text. In some examples, the system(s) may generate the final text using the chapter(s), such as by combining one or more portions of the audio text associated with the chapter(s) with one or more portions of the video text associated with the chapter(s). In some examples, the system(s) may use one or more models—such as one or more language models (and/or any other type of model)—to combine the audio text with the video text when generating the final text. Still, in other examples, the system(s) may use any other technique to combine the audio text with the video text.

The system(s) may then partition the final text into portions, which are also referred to as “chunks.” For instance, in some examples, a chunk may include a word, a sentence, a paragraph, a specific number of characters, a specific number of words, a specific time period, and/or the like associated with the final text. Additionally, in some examples, the system(s) may add additional metadata to the chunks, such as metadata that represents an identifier of the video, an identifier of a file associated with the video, a chapter description, and/or any other information that is relevant to the chunks. The system(s) may then process the chunks using one or more models—such as one or more embedding models (and/or any other type of model)—to generate embeddings associated with the chunks. Additionally, the system(s) may store data representing the embeddings in one or more databases. In some examples, the system(s) may store additional data in association with the embeddings, such as data representing the identifier of the video, the timestamps associated with the chunks, and/or any other information that is relevant to the chunks.

As described herein, the system(s) (and/or one or more other systems) may then perform one or more tasks using the stored data. For example, the system(s) may receive input data representing a query from a user. The system(s) may then analyze the data stored in the database(s) to identify information that is related to the query. For instance, in some examples, the system(s) may generate one or more additional embeddings associated with the query, use the additional embedding(s) to identify one or more of the stored embedding(s) that is related to the query, and then identify the information as being related to the identified embedding(s). The system(s) may then process the query augmented with the additional information using one or more models—such as one or more language models (and/or any other type of model)—to determine a response to the query for the user.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

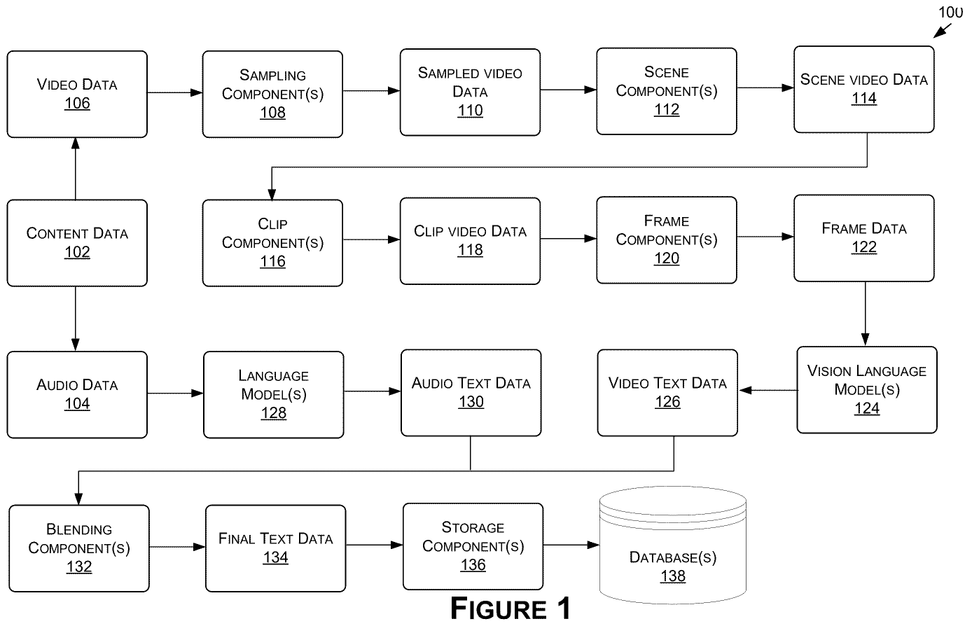

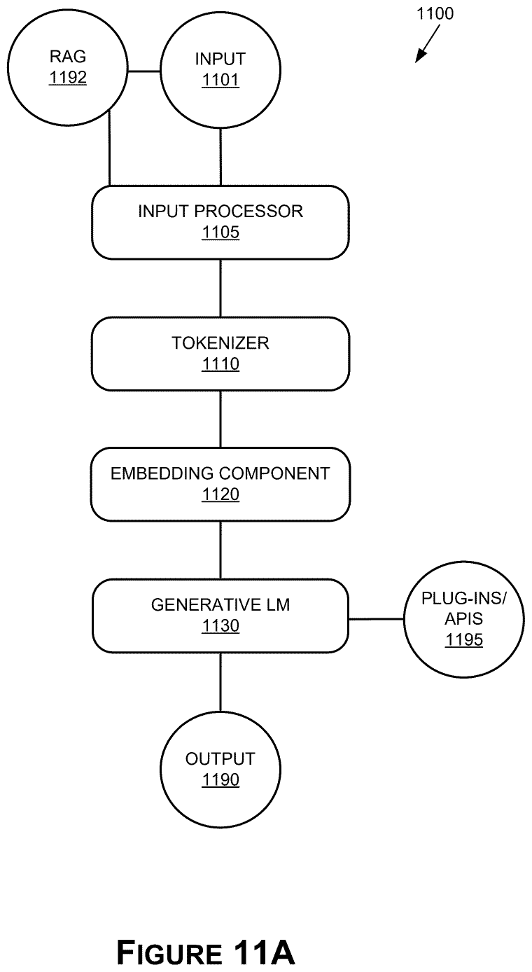

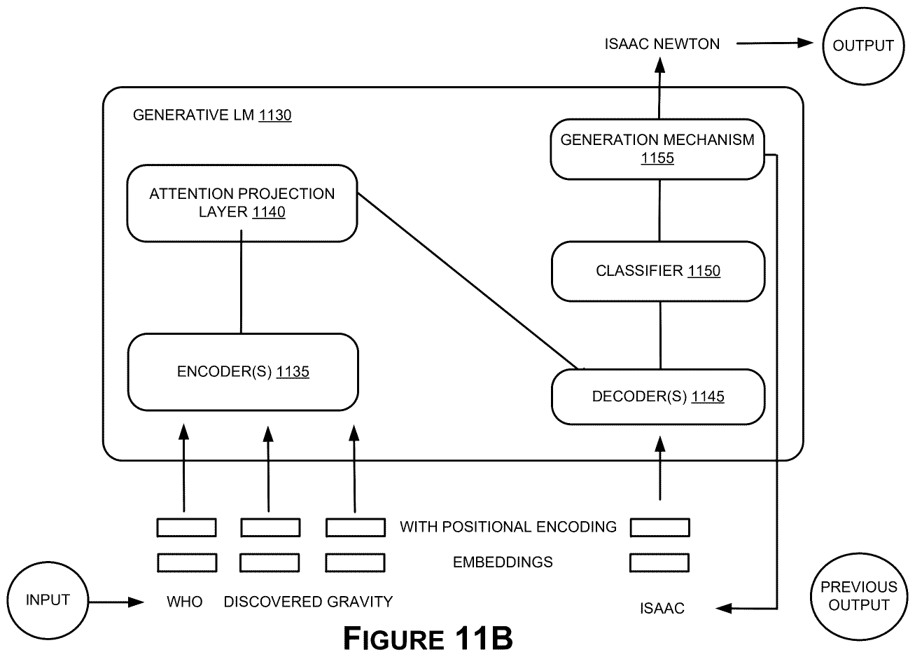

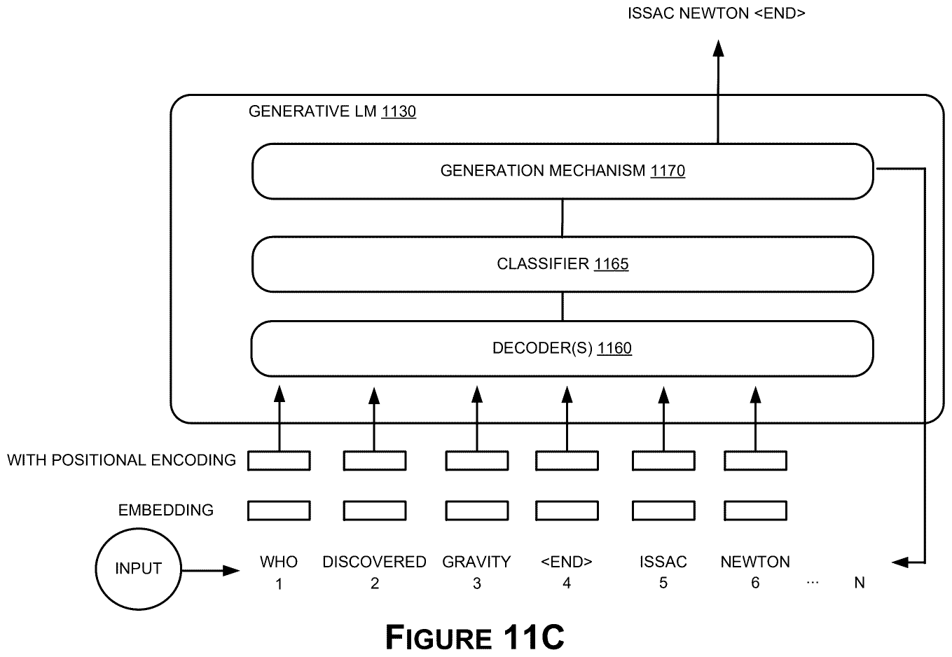

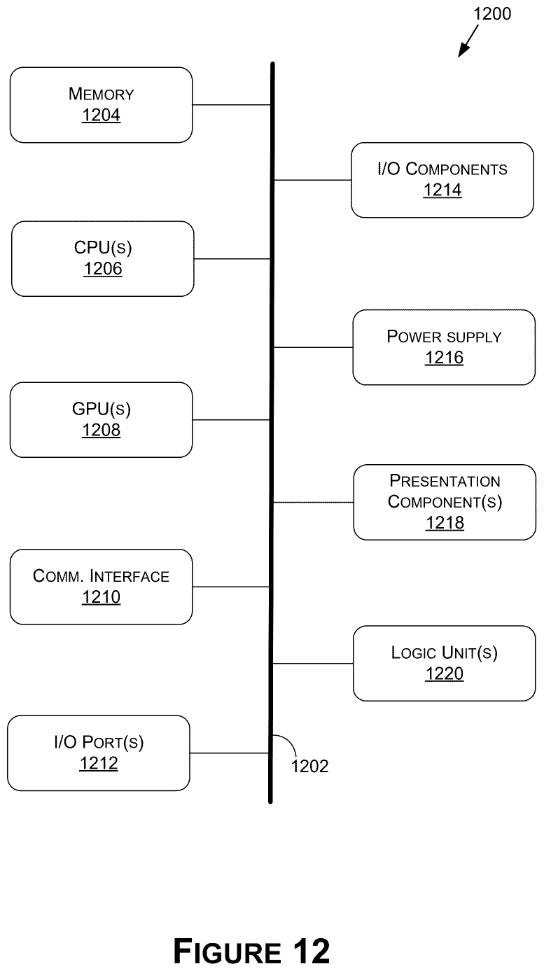

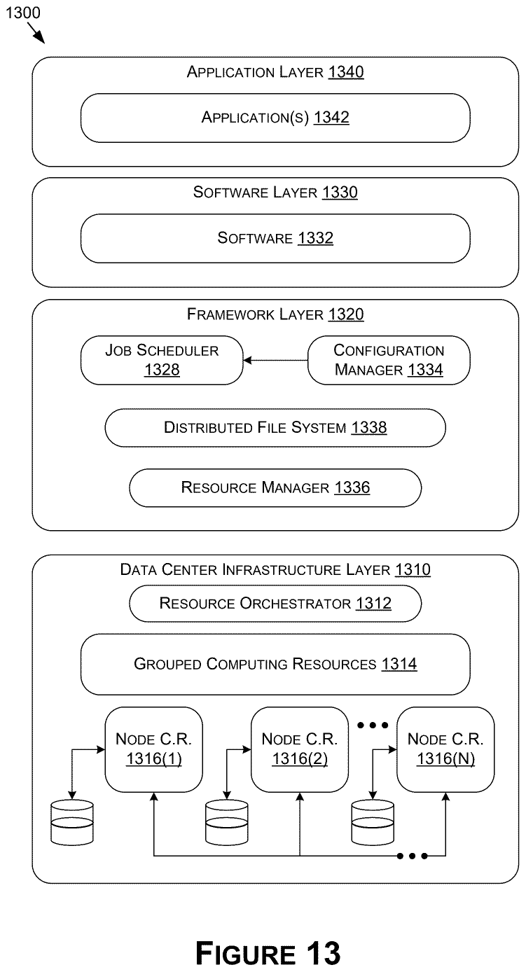

With reference to FIG. 1, FIG. 1 illustrates an example of a data flow diagram for a process 100 of using multimodal processing in a content retrieval system, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 11A-11C), one or more computing devices or components thereof (e.g., as described in FIG. 12), and/or one or more data centers or components thereof (e.g., as described in FIG. 13).

As shown, the process 100 may include obtaining content data 102 representing a video that is to be captured and indexed for information retrieval. As described herein, in some examples, the video may include a specific type of video, such as a structured video where the frames include a defined structure or pattern, an unstructured video where the frames have no innate structure and/or pattern, and/or any other type of video that is between a structured video and an unstructured video. For instance, the video may include a structured video such as a recorded lecture, a recorded meeting, a keynote presentation, an educational presentation, and/or any other type of tutorial where the frames of the video may be individually understood without relying on the sequence of frames for understanding. For example, the video may include a presentation of slides that includes information, where a speaker is discussing the information included in the slides. The process 100 may then include separating the content data 102 into different modalities of data, such as audio data 104 representing sound corresponding to the video along with video data 106 representing the frames of the video.

The process 100 may then include using one or more sampling components 108 to process the video data 106 using one or more downsampling techniques in order to reduce the number of frames represented by the video data 106. In some examples, the sampling component(s) 108 may perform downsampling based on the type of video—such as the video including a structured video—where many of the frames may represent the same information. Additionally, the sampling component(s) 108 may perform the downsampling of the video data 106 using a specific framerate. For instance, if the video data 106 is captured using a first framerate—such as 60 FPS (and/or any other framerate)—then the downsampling may reduce the first framerate to a second, lower framerate (e.g., 4 FPS). The output from the sampling component(s) 108 may include sampled video data 110 representing the video with the reduced number of frames.

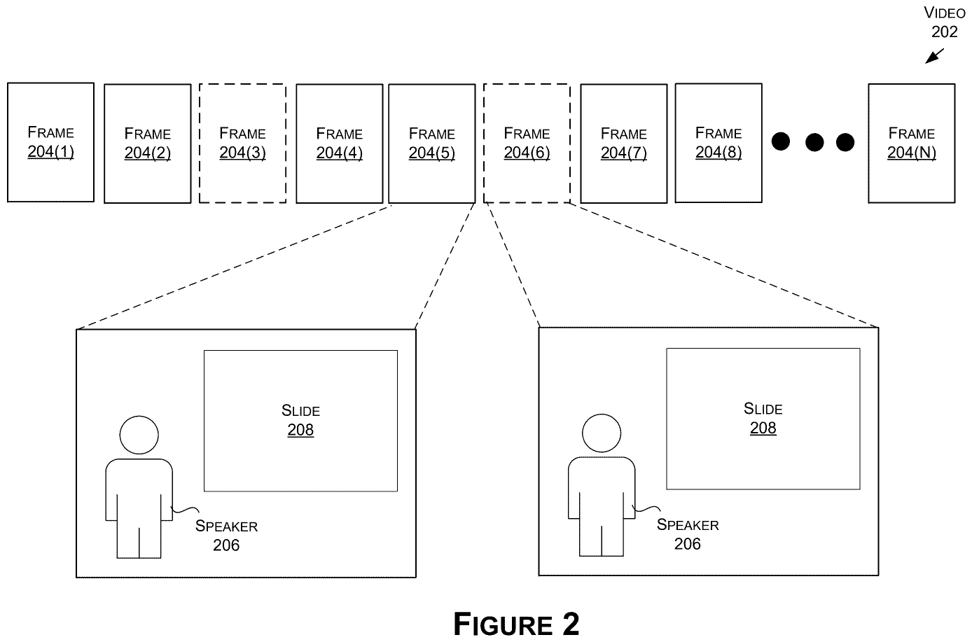

For more details, FIG. 2 illustrates an example of performing downsampling on a video 202 in order to reduce a number of frames, in accordance with some embodiments of the present disclosure. As shown, the video may initially include frames 204(1)-(N) (also referred to singularly as “frame 204” or in plural as “frames 204”) that are associated with a first framerate. The sampling component(s) 108 may then perform one or more of the downsampling processes described herein to reduce the number of frames associated with the video 202. For instance, in some examples, the sampling component(s) 108 may use an interval to remove one or more of the frames 204, such as by removing every other frame 204, every third frame 204, every fourth frame 204, every tenth frame 204, and/or using any other interval. In some examples, the sampling component(s) 108 may use an interval to select one or more of the frames 204 to keep, such as by selecting every other frame 204, every third frame 204, every fourth frame 204, every tenth frame 204, and/or using any other interval. In some examples, the sampling component(s) 108 may randomly remove and/or randomly select one or more of the frames 204. Still, in some examples, the sampling component(s) may use any other technique to perform the downsampling associated with the video 202.

In the example of FIG. 2, the sampling component(s) 108 may remove at least the third frame 204(3) and the sixth frame 204(6) from the video 202, which is indicated by the dashed lines. As described herein, in some examples, the sampling component(s) 108 may be able to perform the downsampling on the video 202, without removing information that may be of importance to the video 202, since many of the frames 204 depict the same information. For instance, and as shown, the fifth frame 204(5) and the sixth frame 204(6) may both depict a speaker 206 discussing a same slide 208, such that information between the consecutive frames 204(5)-(6) remains constant. As such, by removing the sixth frame 204(6), the video 202 may still depict the same information even with less of the frames 204.

Referring back to the example of FIG. 1, the process 100 may include using one or more scene components 112 to process at least the sampled video data 110 and identify one or more chapters associated with the video. As described herein, the scene component(s) 112 may identify the chapter(s) to create a local context to judge information that is present in the frames. Additionally, the scene component(s) 112 may use one or more computer vision techniques that leverage patterns in a changing color space between frames, one or more detection models that detect the changing patterns, and/or any other type of scene detection technique to identify the chapter(s) of the video. For instance, in some examples, the scene component(s) 112 may include and/or use one or more models and/or detectors, such as a convolution neural network, a recurrent neural network, a graph neural network, a hybrid model, a content-aware detector, a threshold detector, an adaptive content detector, a histogram detector, a perceptual hash detector, and/or the like to perform scene detection to identify the chapter(s).

For an example, the scene component(s) 112 may process the sampled video data 110 to identify differences in visual attributes associated with consecutive frames. As described herein, a visual attribute may include, but is not limited to, differences in content in the HSV color space, differences in brightness, differences in the Y channel of the YCbCr color space, difference in hashes associated with color attributes, and/or any other type of visual attribute difference. The scene component(s) 112 may then use the visual attribute differences to identify boundaries associated with the chapter(s). For instance, in some examples, the scene component(s) 112 may detect a boundary based at least on a visual attribute difference satisfying a threshold. As shown, the scene component(s) 112 may then output scene video data 114 representing the chapter(s) associated with the video.

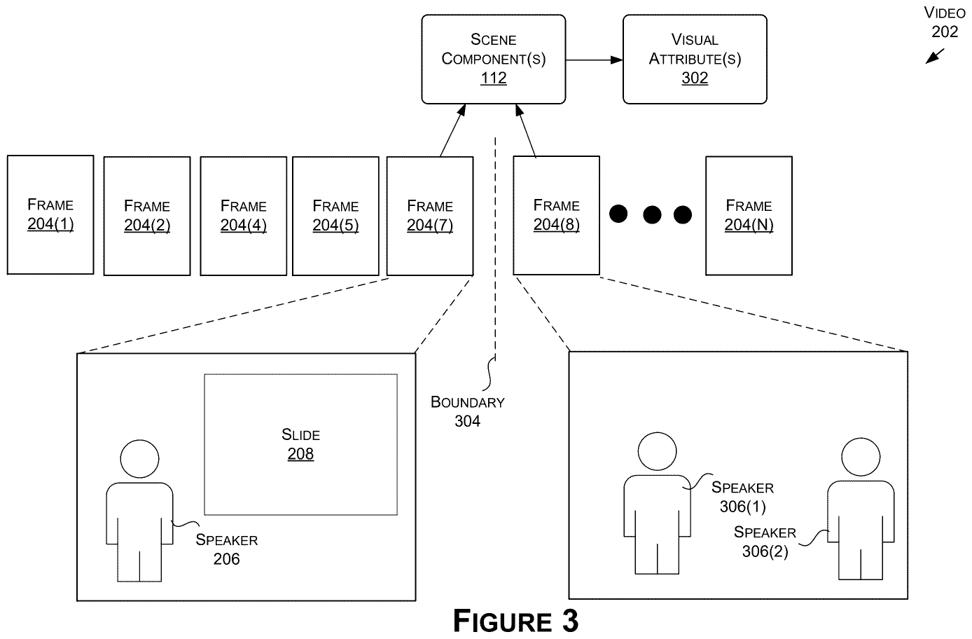

For more details, FIG. 3 illustrates an example of performing scene detection to identify one or more chapters associated with the video 202, in accordance with some embodiments of the present disclosure. As shown, the scene component(s) 112 may process video data representing at least the seventh frame 204(7) and the eighth frame 204(8) from the video 202, where the seventh frame 204(7) and the eighth frame 204(8) include consecutive frames. Based at least on the processing, the scene component(s) 112 may determine one or more differences between one or more visual attributes 302 associated with the frames 204(7)-204(8). Additionally, the scene component(s) 112 may use the difference(s) between the visual attribute(s) 302 to detect a boundary 304 associated with a chapter within the video 202. For instance, in some examples, the scene component(s) 112 may detect the boundary 304 based at least on the difference(s) in the visual attribute(s) 302 satisfying one or more thresholds. As such, the scene component(s) 112 may identify a chapter that includes at least the frames 204(1)-(2042), 204(4)-204(5), and 204(7).

For instance, in the example of FIG. 3, the frames 204(1)-204(2), 204(4)-204(5), and 204(7) may depict the speaker 206 presenting slides associated with a topic of a presentation. However, the eighth frame 204(8) may then depict two different speakers 306(1)-306(2) communicating with one another, such as to discuss a new topic associated with the presentation. As such, the scene component(s) 112 may use the differences between the visual attribute(s) to determine that there is no scene change between the frames 204(1)-204(2), 204(4)-204(5), and 204(7). However, the scene component(s) 112 may further use the differences in the visual attribute(s) 302 to determine that there is a scene change between the seventh frame 204(7) and the eighth frame 204(8), where the boundary 304 indicates the scene change. In some examples, the scene component(s) 112 may then continue to perform these processes to detect one or more additional chapter boundaries associated with the video 202 and use the one or more additional chapter boundaries to identify one or more additional chapters associated with the video 202.

Referring back to the example of FIG. 1, the process 100 may include using one or more clip components 116 to process at least the scene video data 114 and identify one or more video clips within the chapter(s). As described herein, the clip component(s) 116 may identify the video clips(s) in order to identify frames that are perceptually unique and/or are capturing some unique activity within the video. Additionally, the clip component(s) 116 may use any technique that identifies differences in concurrent frames—such as pixel characteristic differences, embedding differences, structural differences, and/or the like—to perform the clip detection.

For instance, and for a chapter of the video, the clip component(s) 116 may process the scene video data 114 representing the frames associated with the chapter to determine similarity scores across consecutive frames. In some examples, the similarity scores may be determined based on pixel characteristic differences, embedding differences, structural differences, and/or any other differences associated with the consecutive frames. The clip component(s) 116 may then identify locations within the chapter where the similarity scores satisfy one or more threshold scores. As described herein, in some examples, a threshold score may include, but is not limited to, a mean score of the chapter, a standard deviation from the mean score of the chapter, a mode score of the chapter, a median score of the chapter, and/or any other score. Additionally, the clip component(s) 116 may use the locations within the chapter to identify one or more video clips associated with the chapter.

For instance, in some examples, the clip component(s) 116 may identify a video clip as starting at a frame that satisfies a threshold score and ending at another frame that no longer satisfies the threshold score and/or another threshold score. However, in other examples, the clip component(s) 116 may identify a video clip using any other technique based on the similarity scores. The clip component(s) 116 may then perform similar processes to identify one or more additional video clips associated with the chapter and/or one or more additional video clips associated with one or more additional chapters of the video. The output from the clip component(s) 116 may then include clip video data 118 representing the video clip(s).

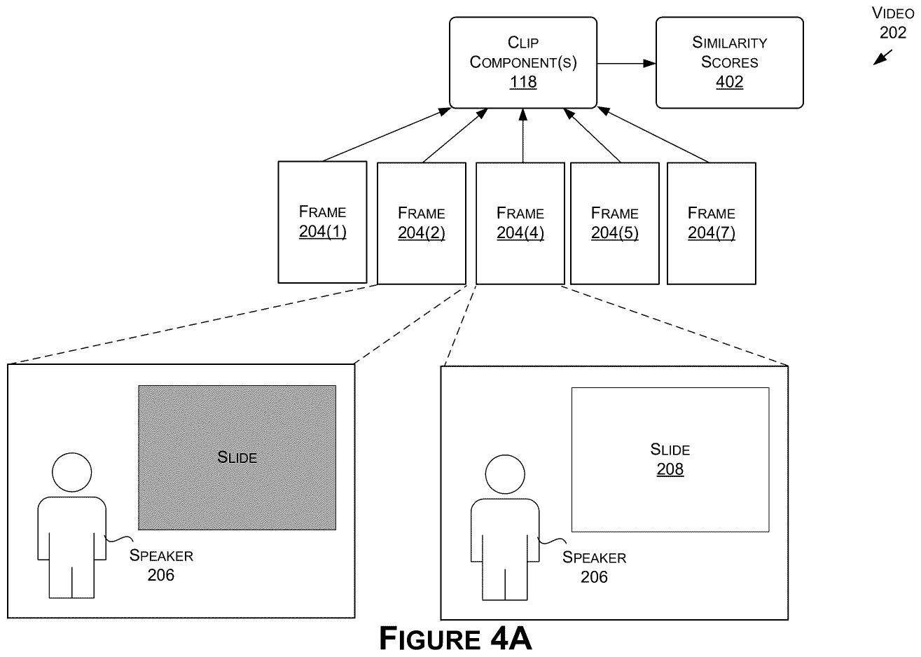

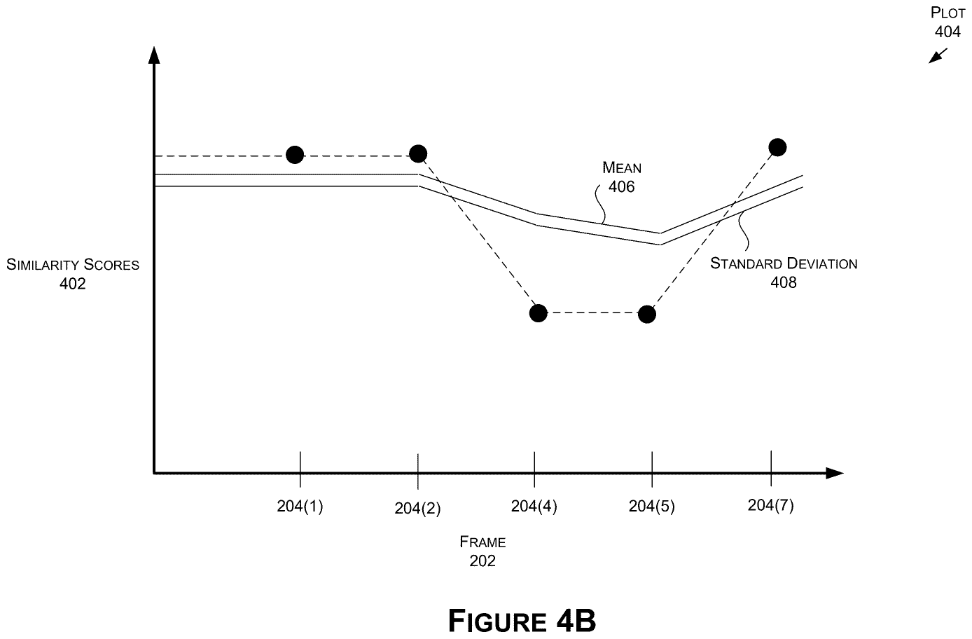

For more details, FIGS. 4A-4B illustrate an example of performing clip detection to identify one or more video clips in a chapter of a video, in accordance with some embodiments of the present disclosure. As shown by the example of FIG. 4A, the clip component(s) 116 may process video data representing the chapter of the video 202 that includes frames 204(1)-204(2), 204(4)-204(5), and 204(7) to determine similarity scores 402 between consecutive frames included in the chapter. In some examples, the similarity scores 402 may be between a range, such as 0 to 1 (and/or any other range). Additionally, the higher the similarity score 402, the more similar two consecutive frames 204 are with respect to one another while the lower the similarity score 402, the less similar the two consecutive frames 204 are with respect to one another.

As described herein, in some examples, to determine the similarity scores 402, the clip component(s) 116 may use one or more image encoders to generate embeddings associated with the frames 204(1)-204(2), 204(4)-204(5), and 204(7). The clip component(s) 116 may then use the embeddings to determine differences between the frames 204(1)-204(2), 204(4)-204(5), and 204(7), where the similarity scores 402 are associated with the differences. For instance, the more similar that two frames 204 are with respect to one another, the more similar the embeddings for the frames 204 may also be which is indicated by a higher similarity score 402. Additionally, the less similar that two frames 204 are with respect to one another, the less similar the embeddings for the frames 204 may also be which is indicated by a lower similarity score 402.

Additionally, or alternatively, in some examples, to determine the similarity scores 402, the clip component(s) 116 may use one or more signal processing filters that capture the structural differences between consecutive frames 204 in order to generate the similarity scores 402. For instance, and for a pair of consecutive frames 204, the signal processing filter(s) may compare the consecutive frames 204 based on one or more factors, such as luminance, contrast, structure (e.g., the patterns and shapes present in the frames 204), and/or the like. Based at least on the comparison, the signal processing filter(s) may determine a Structural Similarity Index (SSIM) associated with the consecutive frames 204, where the SSIM may include the similarity score 402 between the consecutive frames 204. Additionally, the clip component(s) 116 may perform similar processes for one or more (e.g., each) of the pairs of the consecutive frames 204 included within the chapter. While these are just two example techniques for how the clip component(s) 116 may determine the similarity scores 402 for the frames 204(1)-204(2), 204(4)-204(5), and 204(7) of the chapter of the video 202, in other examples, the clip component(s) 116 may use additional and/or alternative techniques.

Next, and as shown by the example of FIG. 4B, the clip component(s) 116 may use the similarity scores 402 to identify at least a clip within the chapter of the video 202. For instance, FIG. 4B illustrates a plot 404 of the similarity scores 402 for the frames 204(1)-204(2), 204(4)-204(5), and 204(7), where the similarity scores 402 are indicated by the black circles. Additionally, the plot 404 may indicates a mean score 406 associated with the chapter and a standard deviation 408 from the mean score 406 associated with the chapter. In some examples, the clip component(s) 116 may identify a clip as starting at a first frame 204 when the similarity scores 402 dip below the mean score 406 and/or the standard deviation 408 and ending at a second frame 204 when the similarity scores 402 again raise above the mean score 406 and/or the standard deviation 408. For instance, in the examples of FIGS. 4A-4B, the clip component(s) 116 may determine that a clip includes the frames 204(4)-204(5). This is because, in some examples, the frames 204(4)-204(5) may be perceptually unique and/or capture some unique activity not depicted by the other frames 204(1)-204(2) and 204(7) of the chapter of the video 202, such as a unique slide.

Referring back to the example of FIG. 1, the process 100 may include using one or more frame components 120 to process at least the clip video data 118 and identify one or more frames within the video clip(s) of the chapter(s). As described herein, in some examples, and for a video clip, the frame component(s) 120 may initially remove one or more frames that include low quality (e.g., frames that are blurred, include bad lighting, etc.), one or more duplicate frames (e.g., frames that depict the same content, etc.), and/or any other frame that may not include important information. The frame component(s) 120 may then select one or more frames from the video clip that include important information. For instance, in some examples, the frame component(s) 120 may select at least a beginning frame from the video clip, an ending frame from the video clip, and/or one or more frames that include one or more high entropies. However, in other examples, the frame component(s) 120 may use any other factors when selecting the frame(s) from the video clip. The output from the clip component(s) 116 may then include frame data 122 representing the selected frame(s) from the video clip(s) of the video.

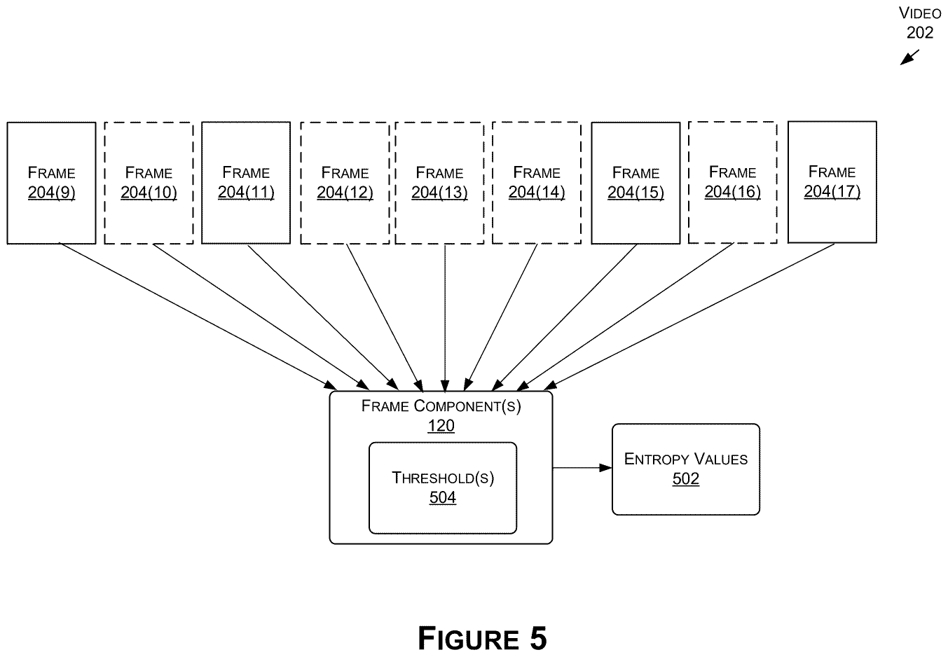

For more details, FIG. 5 illustrates an example of performing frame selection to select frames from a video clip of the video 202, in accordance with some embodiments of the present disclosure. As shown, the clip of the video 202 may include at least frames 204(9)-204(17). As such, the frame component(s) 120 may perform one or more of the processes described herein to select one or more of the frames 204(9)-204(17), such as the frames 204 that may contain important information associated with the video 202. For instance, in some examples, the frame component(s) 120 may select at least the starting frame 204(9) and the ending frame 204(17) from the video clip, which respectively include the ninth frame 204(9) and the seventeenth frame 204(17) from the video 202 and are indicated by solid borders. This is because the starting frame 204(9) and the ending frames 204(17) from the video clip may include important information. For example, such as when the video 202 depicts a presentation, at least the ending frame 204(17) may depict all of the information of a slide (and/or other type of presentation tool) that is being displayed during the presentation.

Additionally, the frame component(s) 120 may process the video data representing the fames 204(9)-204(17) to determine entropy values 502 associated with the frames 204(9)-204(17) of the video clip. As described herein, in some examples, an entropy value 502 for a frame 204 may measure the uncertainty and/or randomness within the frame 204. For instance, the entropy value 502 may indicate a variation in pixel values and/or other features within the frame 204, with a high entropy value indicating more unpredictable and/or complex content within the frame 204. In some examples, the frame component(s) 120 may determine the entropy value 502 by creating a probability histogram for the pixel values (and/or other features) of the frame 204. The frame component(s) 120 may then apply a formula to the histogram—such as a Shannon entropy formula (and/or any other type of formula)—to measure the entropy value 502 associated with the frame 204. In such examples, if the frame 204 includes uniform color, then the entropy value 502 may be low, and if the frame 204 includes many different colors and/or textures, than the entropy value 502 may be high. However, in other examples, the frame component(s) 120 may use any other technique to measure the entropy values 502 (and/or any other types of values).

The frame component(s) 120 may then use the entropy values 502 to select one or more of the frames 204(9)-204(17) from the video clip. For instance, in some examples, the frame component(s) 120 may select the frames 204(9)-204(17) that include entropy values 502 that satisfy (e.g., are equal to or greater than) one or more thresholds 504. For example, and as shown by the solid lines, the frame component(s) 120 may further select at least the eleventh frame 204(11) and the fifteenth frame 204(15) based at least on the entropy values 502 for the eleventh frame 204(11) and the fifteenth frame 204(15) satisfying a threshold 504. In other words, based on the entropy values 502, the frame component(s) 120 may determine that the eleventh frame 204(11) and the fifteenth frame 204(15) include important information and/or significantly more information than the other frames 204(9)-204(10), 204(12)-204(14), and 204(16)-204(17) included in the video clip.

Referring back to the example of FIG. 1, the process 100 may include using one or more vision language models (VLM(s)) 124 to process the frame data 122 representing the selected frame(s) and generate video text data 126 representing video text associated with the video. For example, the video text may describe text that is depicted by the selected frame(s), one or more objects depicted by the selected frame(s), one or more actions depicted by the selected frame(s), and/or any other characteristics and/or attributes associated with the selected frame(s). Additionally, in some examples, the video text data 126 may represent additional information associated with the video text, such as timestamps associated with individual portions of the video text. For example, and for a portion of the video text that is associated with a selected frame, the timestamp may indicate a location of the selected frame within the video. As described herein, a portion of the video text may include, but is not limited to, one or more characters, words, sentences, paragraphs, and/or any other portion of the video text.

The process 100 may also include using one or more language models 128—such as one or more ASR models, one or more NLU models, and/or any other type of language model—to process the audio data 104 and generate audio text data 130 representing audio text associated with the audio. For instance, in some examples, the audio text may include a transcript of the speech represented by the audio data 104 and/or included in the video. Additionally, in some examples, the audio text data 130 may represent additional information associated with the audio text, such as timestamps associated with individual portions of the audio text. For example, the timestamps may indicate locations within the video for which the speech corresponding to the portions of the audio text occurs. As described herein, a portion of the audio text may include, but is not limited to, one or more characters, words, sentences, paragraphs, and/or any other portion of the audio text.

The process 100 may then include using one or more blending components 132 that blend the video text represented by the video text data 126 and the audio text represented by the audio text data 130 to generate final text data 134 representing the final text associated with the video. For instance, in some examples, the blending component(s) 132 may use the timestamps associated with the audio text and the timestamps associated with the video text to input portions of the video text into the audio text in chronological order to generate the final text. In some examples, the blending component(s) 132 may generate the final text using the chapter(s), such as by combining the audio text associated with the chapter(s) with the video text associated with the chapter(s). In some examples, the blending component(s) 132 may use one or more models—such as one or more language models (and/or any other type of model)—to combine the audio text with the video text when generating the final text. Still, in other examples, the blending component(s) 132 may use any other technique to combine the audio text with the video text.

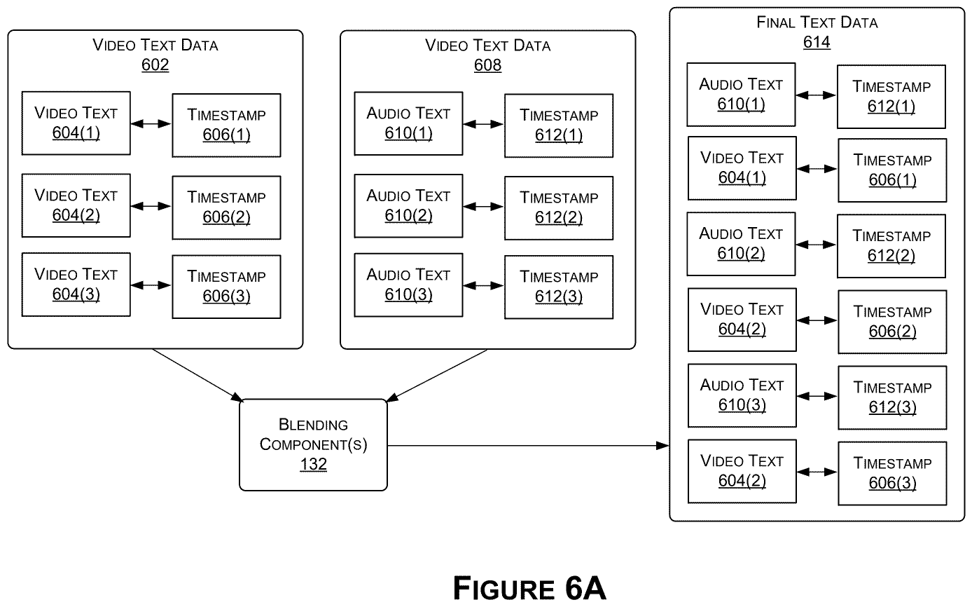

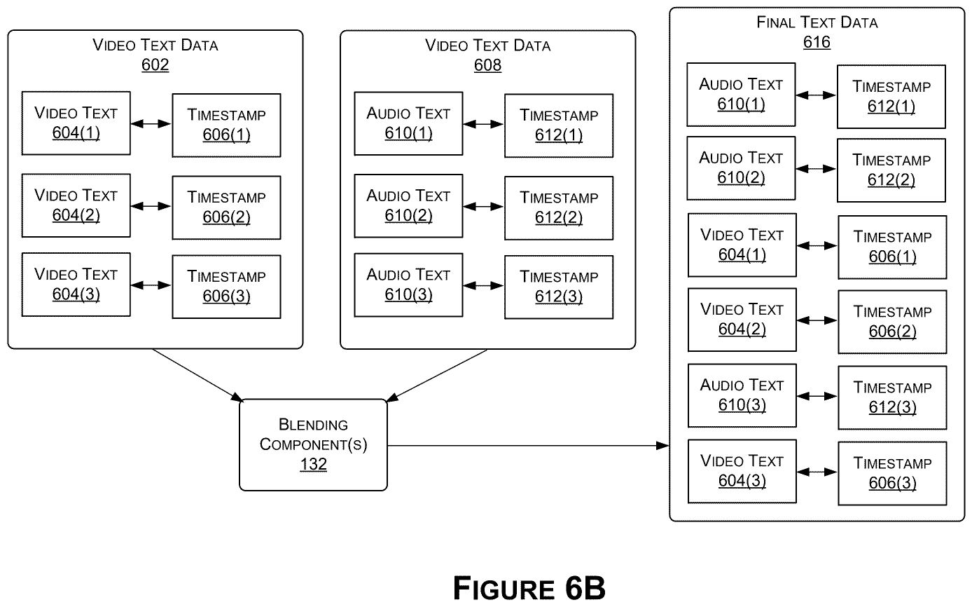

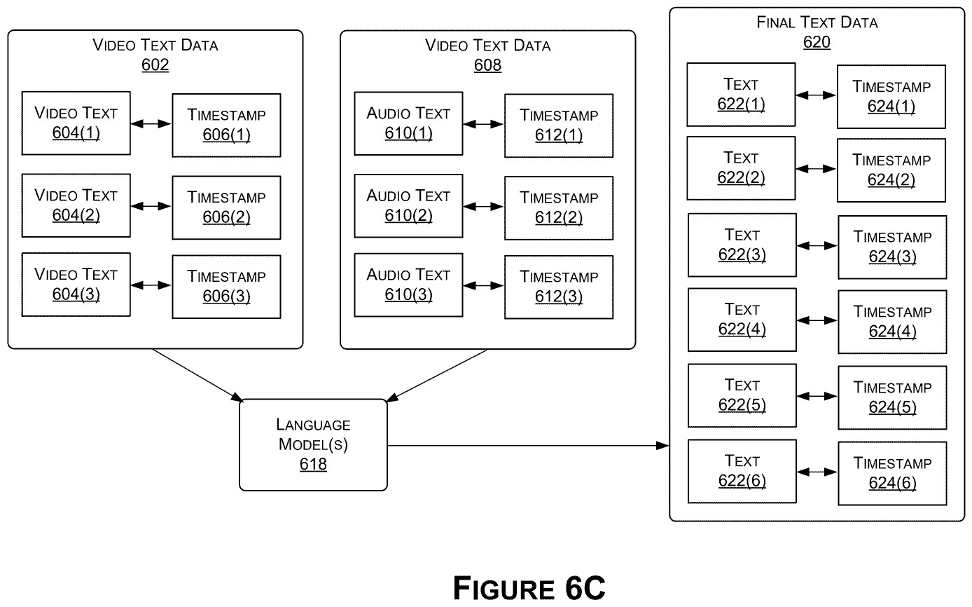

For instance, FIGS. 6A-6C illustrate examples of blending video text with audio text in order to generate final text associated with the video 202, in accordance with some embodiments of the present disclosure. As shown, video text data 602 may represent video text portions 604(1)-604(3) for different frames 204 of the video 202 along with timestamps 606(1)-606(3) indicating the locations of the frames 204 within the video 202. In the examples of FIGS. 6A-6C, the video text portions 604(1)-604(2) may be associated with a first chapter of the video 202 and the video text portion 604(3) may be associated with a second chapter of the video 202. Additionally, audio text data 608 may then represent audio text portions 610(1)-610(3) representing different portions of a transcript of speech associated with the video 202 along with timestamps 612(1)-612(3) indicating the locations at which the audio text portions 610(1)-610(3) occur within the video 202. As such, the blending component(s) 132 may perform one or more techniques to blend the video text data 602 with the audio text data 608.

For instance, and as illustrated in the example of FIG. 6A, the blending component(s) 132 may use the timestamps 606(1)-606(3) from the video text data 602 and the timestamps 612(1)-612(3) from the audio text data 608 to chronologically blend the video text portions 604(1)-604(3) with the audio text portions 610(1)-610(3). For example, and as shown, the blending component(s) 132 may input the first video text portion 604(1) between the audio text portions 610(1)-610(2) based on the first timestamp 606(1) indicating a location within the video 202 that is between the locations indicated by the timestamps 612(1)-612(2), input the second video text portion 604(2) between the audio text portions 610(2)-610(3) based on the second timestamp 606(2) indicating a location within the video 202 that is between the locations indicated by the timestamps 612(2)-612(3), and input the third video text portion 604(3) after the third audio text portion 610(3) based on the third timestamp 606(3) indicating a location within the video 202 that is after a location indicated by the third timestamp 612(3). As such, the blending component(s) 132 may generate final text data 614 representing the blended text.

Next, and as illustrated in the example of FIG. 6B, the blending component(s) 132 may determine that the video text portions 604(1)-604(2) are associated with the first chapter and the video text portion 604(3) is associated with the second chapter. Additionally, the blending component(s) may use the timestamps 606(1)-606(3) and the timestamps 612(1)-612(3) to determine that the audio text portions 610(1)-610(2) are also associated with the first chapter and the audio text portion 610(3) is also associated with the second chapter. As such, the blending component(s) 132 may combine the video text portions 604(1)-604(2) with the audio text portions 610(1)-610(2) and combine the video text portion 604(3) with the audio text portion 610(3). As such, the blending component(s) 132 may generate final text data 616 representing the blended text.

Next, and as illustrated in the example of FIG. 6C, the blending component(s) 132 may use one or more language models 618 to process the video text data 602 and the audio text data 608. Based at least on the processing, the language model(s) 618 may generate final text data 620 representing final text 622(1)-622(6) associated with the video 202. For example, the final text 622(1)-622(6) may represent a summary, description, transcript, and/or any other type of writing associated with the video text portions 604(1)-604(3) and the audio text portions 610(1)-610(3). Additionally, in some examples, the final text data 620 may represent timestamps 624(1)-624(6) associated with the final text 622(1)-622(6). While the examples of FIGS. 6A-6C illustrate three example techniques that the blending component(s) 132 may use to blend the video text portions 604(1)-604(3) represented by the video text data 602 with respect to the audio text portions 610(1)-610(3) represented by the audio text data 608, in other examples, the blending component(s) 132 may use additional and/or alternative techniques.

Referring back to the example of FIG. 1, the process 100 may include using one or more storage components 136 to process the final text data 134 and generate data representing the final text for storage in one or more databases 138. For instance, in some examples, the storage component(s) 136 may partition the final text into portions, which are also referred to as “chunks.” For instance, in some examples, a chunk may include a word, a sentence, a paragraph, a specific number of characters, a specific number of words, a specific time period, and/or the like associated with the final text. Additionally, in some examples, the storage component(s) 136 may add additional metadata to the chunks, such as metadata that represents an identifier of the video, an identifier of a file associated with the video, a chapter description, timestamps, and/or any other information that is relevant to the chunks. The storage component(s) 136 may then process the chunks using one or more models—such as one or more embedding models (and/or any other type of model)—to generate embeddings associated with the chunks. Additionally, the storage component(s) 136 may store data representing the embeddings in the database(s) 138. In some examples, the storage component(s) 136 may store additional data in association with the embeddings, such as data representing the identifier of the video, the chapter descriptions, the timestamps associated with the chunks, and/or any other information that is relevant to the chunks.

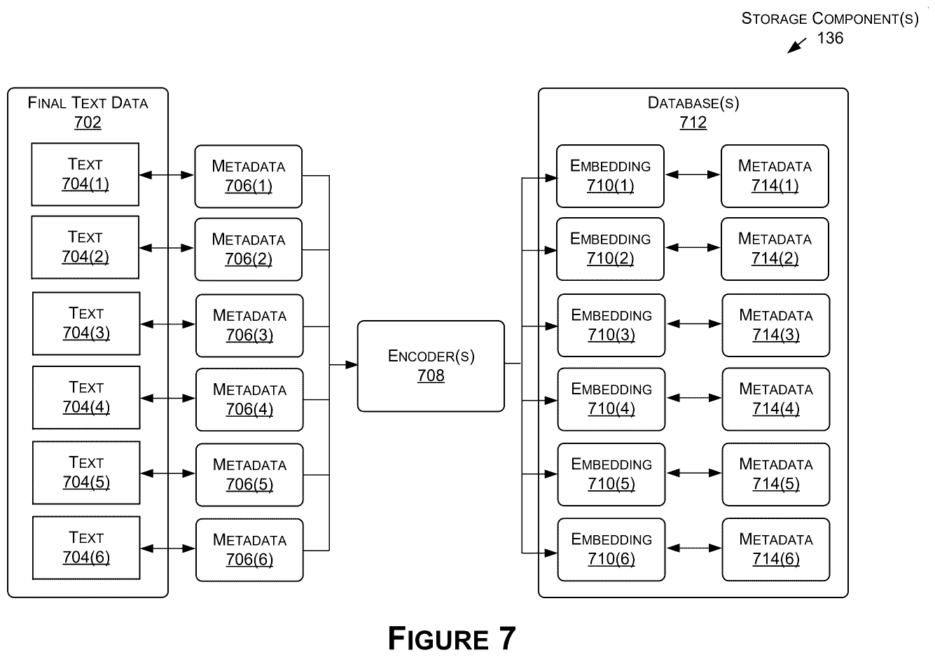

For instance, FIG. 7 illustrates an example of generating and storing final text associated with the video 202 in one or more databases, in accordance with some embodiments of the present disclosure. As shown, the storage component(s) 136 may initially process final text data 702 (which may include, and/or be similar to, the final text data 614, the final text data 616, and/or the final text data 620) representing final text 704(1)-704(6). As shown, the processing may include partitioning the final text 704(1)-704(6) into the individual chunks illustrated by the example of FIG. 7. For instance, in some examples, the storage component(s) 136 may partition the final text 704(1)-704(6) into words, sentences, paragraphs, specific numbers of characters, specific numbers of words, specific time periods, and/or any other portions of text.

Additionally, in some examples, the storage component(s) 136 may associate the individual chunks of the final text 704(1)-704(6) with metadata 706(1)-706(6). As described herein, the metadata 706(1)-706(6) may represent information associated with the chunks, such as an identifier of the video 202, an identifier of the file associated with the video 202, chapter descriptions, timestamps, and/or any other information. For instance, and with regard to the first chunk of final text 704(1), the first metadata 706(1) may represent a name of the video 202, a name of the file for which the video 202 is stored, a description of the chapter of the video 202 for which the first chunk is associated within the video 202, a timestamp within the video 202 for which the first chunk is associated, and/or any other information associated with the first chunk of the final text 704(1). In some examples, associating the final text 704(1)-704(6) with the metadata 706(1)-706(6) may include adding the text represented by the metadata 706(1)-706(6) to the chunks of the final text 704(1)-704(6).

The storage component(s) 136 may then process the final text data 702 representing the chunks of the final text 704(1)-704(6) along with the associated metadata 706(1)-706(6) using one or more encoders 708. Based at least on the processing, the encoder(s) 708 may generate embeddings 710(1)-710(6) representing the chunks of the final text 704(1)-704(6). Additionally, the storage component(s) 136 may then store the embeddings 710(1)-710(6) in one or more databases 712 (which may include, and/or be similar to, the database(s) 138). As shown, in some examples, the storage component(s) 136 may associate the embeddings 710(1)-710(6) with additional metadata 714(1)-714(6) associated with the chunks of the final text 704(1)-704(6). For instance, the metadata 714(1)-714(6) may represent the identifier of the video 202, the identifier of the file associated with the video 202, the chapter descriptions, the timestamps, and/or any other information.

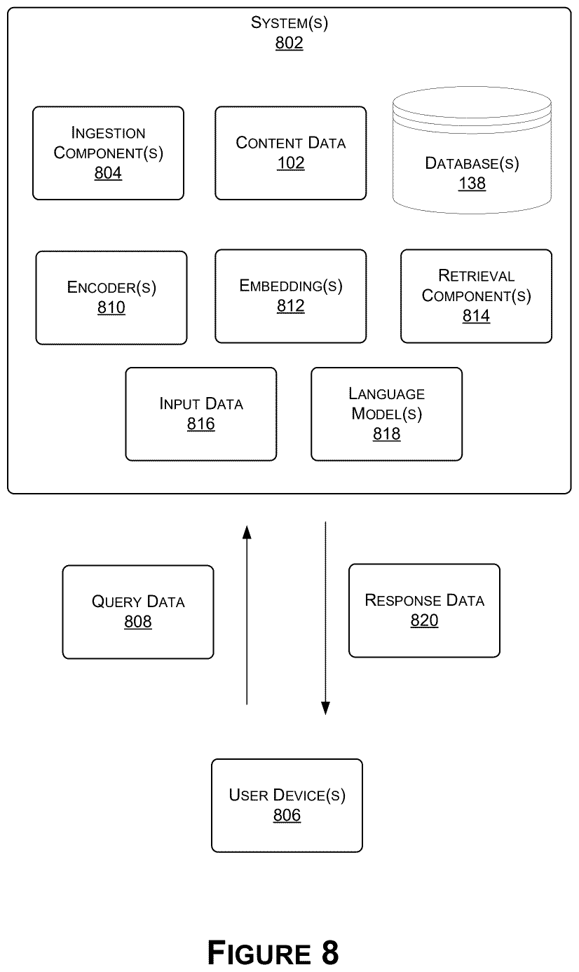

Referring back to the example of FIG. 1, in some examples, the process 100 may be performed with respect to one or more additional videos in order to generate data—such as embeddings—associated with the video(s) for storage in the database(s) 138. Additionally, as described herein, the process 100 of generating the data for storage in the database(s) 138 may be performed with regard to one or more additional systems, such as an information retrieval system (e.g., a retrieval-augmented generation (RAG) system). For instance, FIG. 8 illustrates an example of one or more information retrieval systems 802 (e.g., the system(s) 802) that use stored data associated with one or more videos to provide information related to queries, in accordance with some embodiments of the present disclosure.

As shown, the system(s) 802 may include one or more ingestion components 804 that are configured to perform at least a portion of the process 100 from the example of FIG. 1 in order to process the content data 102 and generate data (e.g., the embeddings) associated with the videos for storage in the database(s) 138. For instance, the ingestion component(s) 804 may include and/or use the sampling component(s) 108, the scene component(s) 112, the clip component(s) 116, the frame component(s) 120, the VLM(s) 124, the language model(s) 128, the blending component(s) 132, and/or the storage component(s) 136. The system(s) 802 may then use at least a portion of the data stored in the database(s) 138 when responding to queries from one or more users.

For instance, the system(s) 802 may receive, from one or more user devices 806 associated with one or more users, query data 808 representing at least a query for information. In some examples, the query may be related to a video, such as by requesting information associated with the video, a portion of the video, and/or the like. The system(s) 802 may then use one or more encoders 810 to process the query data 808 and generate one or more embeddings 812 associated with the query. For example, the embedding(s) 812 may include one or more text embeddings that represent the text of the query.

The system(s) 802 may then use one or more retrieval components 814 to retrieve information related to the query based at least on the embedding(s) 812. For instance, the retrieval component(s) 814 may analyze the embeddings stored in the database(s) 138 with respect to the embedding(s) 812 to identify one or more stored embeddings that are related to the embedding(s) 812. As described herein, the retrieval component(s) 814 may use any technique to identify the stored embedding(s) that is related to the embedding(s) 812. For example, the retrieval component(s) 814 may measure similarities and/or distances between the stored embeddings and the embedding(s) 812 in a vector space—such as by using cosine similarities, Euclidean distances, and/or any other measurement—and use the similarities and/or distances to identify the stored embedding(s). In some examples, the retrieval component(s) 814 may initially rank at least a portion of the stored embeddings based at least on the similarities and/or distances and then use the ranking to identify the stored embedding(s), such as by identifying a top number of the highest-ranking stored embeddings. Additionally, or alternatively, in some examples, the retrieval component(s) 814 may identify the stored embedding(s) as including one or more similarity scores that satisfy a threshold score.

The retrieval component(s) 814 may then use the stored embedding(s) that is identified as being related to the embedding(s) 812 to retrieve one or more chunks of the final text associated with the video that are related to the query. For example, the retrieval component(s) 814 may identify the chunk(s) as being associated with the stored embedding(s) identified from the database(s) 138. Additionally, the retrieval component(s) 814 may generate input data 816 that represents at least the query and the chunk(s) of the final text that is related to the text of the query. For example, the input data 816 may represent the text of the query with the added chunk(s) of the final text.

The system(s) 802 may then process at least the input data 816 using one or more language models 818 to generate response data 820 representing a response to the query. For instance, in some examples, the response may include information associated with the video, a portion of the video, and/or any other content associated with the video as being requested by the user(s). Additionally, the system(s) 802 may then send the response data 820 to the user device(s) 806 in order to provide the user(s) with the response. By performing one or more of the processes described herein, the system(s) 802 may be able to provide users with more relevant information associated with queries since the chunks of the final text that are added to queries are more relevant to the requests being made by the users.

As described herein, in the examples herein, a component may include, but is not limited to, a machine learning model, a neural network, a classifier, an application, an algorithm, a module, a processor, software, hardware, and/or any other type of processing component that is configured to perform at least a portion of the processing described herein. Additionally, the system(s) 802 from the example of FIG. 8 may include one or more additional hardware components, such as at least the memory 1204, the CPU(s) 1206, the GPU(s) 1208, the communication interface(s) 1210, and/or the like from an example computing device(s) 1200 of FIG. 12. For example, the system(s) 802 may include one or more example computing devices 1200.

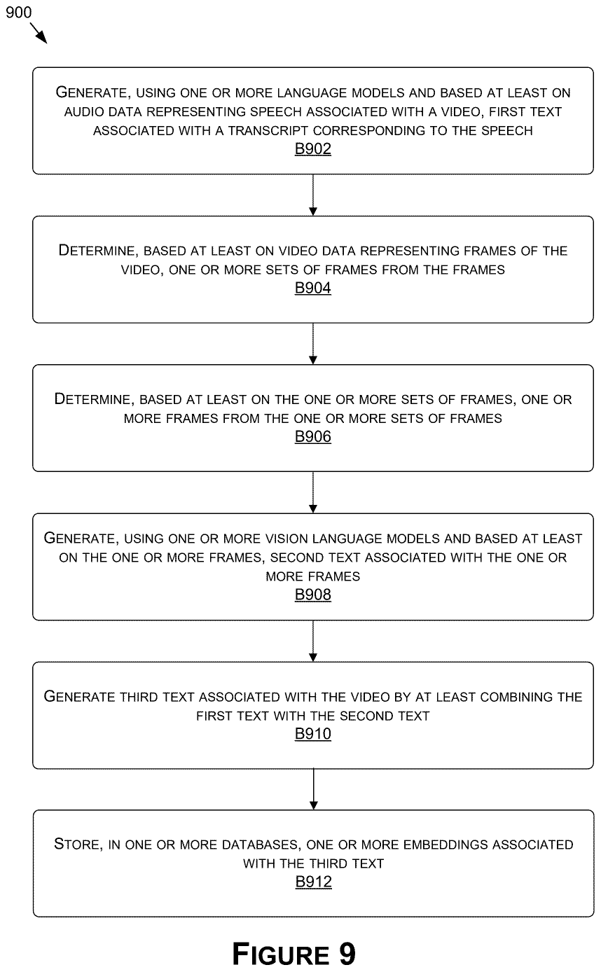

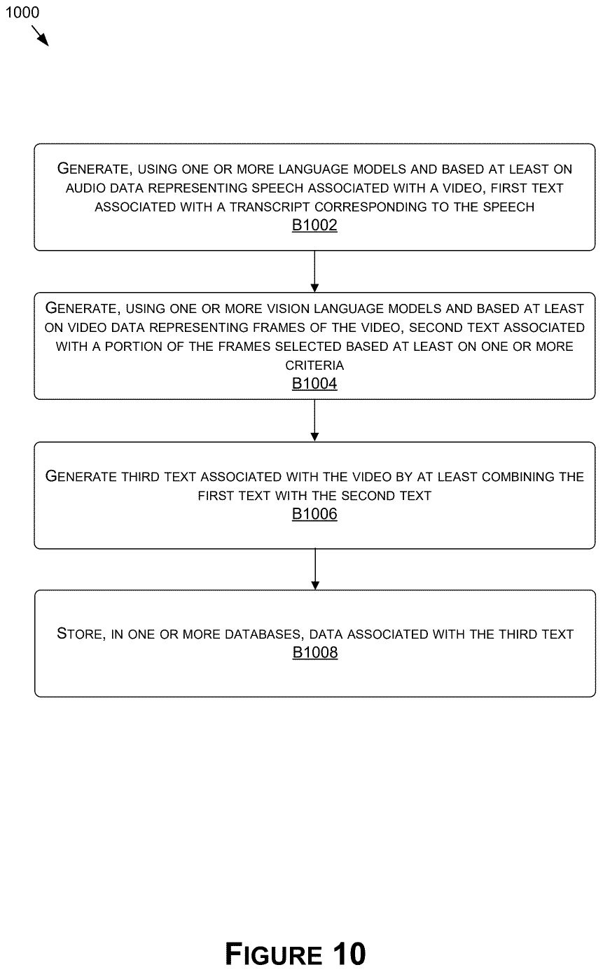

Now referring to FIGS. 9 and 10, each block of methods 900 and 1000, described herein, comprises a computing process that may be performed using any combination of hardware, firmware, and/or software. For instance, various functions may be carried out using one or more processors executing instructions stored in one or more memories. The methods 900 and 1000 may also be embodied as computer-usable instructions stored on computer storage media. The methods 900 and 1000 may be provided by a standalone application, a service or hosted service (standalone or in combination with another hosted service), as a microservice via an application programming interface (API) or a plug-in to another product, to name a few. In addition, the method 900 and 1000 are described, by way of example, with respect to FIG. 1. However, these methods 900 and 1000 may additionally or alternatively be executed by any one system, or any combination of systems, including, but not limited to, those described herein.

FIG. 9 illustrates a flow diagram showing a method 900 for processing multimodal data to generate information related to a video for storage, in accordance with some embodiments of the present disclosure. The method 900, at block B902, may include generating, using one or more language models and based at least on audio data representing speech associated with a video, first text associated with a transcript corresponding to the speech. For instance, the language model(s) 128 may process the audio data 104 representing sound associated with the video, such as the speech from the video. Based at least on the processing, the language model(s) 128 may generate the audio text data 130 representing the audio text associated with the video. As described herein, the audio text may include at least a transcript associated with the speech from the video.

The method 900, at block B904, may include determining, based at least on video data representing frames of the video, one or more sets of frames from the frames. For instance, the scene component(s) 112 may process the video data 106 (and/or the sampled video data 110) representing the frames of the video. Based at least on the processing, the scene component(s) 112 may identify one or more chapters of the video. In some examples, the chapter(s) of the video may then correspond to set(s) of frames. However, in some examples, the clip component(s) 116 may then further process the scene video data 114 representing the chapter(s) of the video to identify one or more video clips associated with the chapter(s). For example, the clip component(s) 116 may identify the video clips(s) based on similarity scores between consecutive frames within individual chapters of the video. In some examples, the video clip(s) may then correspond to the set(s) of frames.

The method 900, at block B906, may include determining, based at least on the one or more sets of frames, one or more frames from the one or more sets of frames. For instance, the frame component(s) 120 may process the scene video data 114 and/or the clip video data 118 to identify the frame(s) from the set(s) of frames. As described herein, in some examples, the frame component(s) 120 may initial determine one or more visual attributes associated with individual frames from the set(s) of frames, such as based on pixel values. The frame component(s) 120 may then measure uncertainty and/or randomness within the individual frames based at least on the visual attribute(s). Additionally, the frame component(s) 120 may use the uncertainty and/or randomness to identify the frame(s).

The method 900, at block B908, may include generating, using one or more vision language models and based at least on the one or more frames, second text associated with the one or more frames. For instance, the VLM(s) 124 may process the frame data 122 representing the frame(s) of the video. Based at least on the processing, the VLM(s) 124 may generate the video text data 126 representing the video text associated with the frame(s) of the video. For example, the video text may describe text that is depicted by the frame(s), one or more objects depicted by the frame(s), one or more actions depicted by the frame(s), and/or any other characteristics and/or attributes associated with the frame(s).

The method 900, at block B910, may include generating third text associated with the video by at least combining the first text and the second text. For instance, the blending component(s) 132 may combine the audio text represented by the audio text data 130 with the video text represented by the video text data 126 to generate the final text associated with the video. As described herein, the blending component(s) 132 may use one or more techniques to combine the video text with the audio text. For instance, in some examples, the blending component(s) 132 may use the timestamps associated with the audio text and the timestamps associated with the video text to input portions of the video text into the audio text in chronological order and generate the final text. In some examples, the blending component(s) 132 may generate the final text using the set(s) of frames, such as by combining the audio text associated with the set(s) of frames with the video text associated with the set(s) of frames. Still, in some examples, the blending component(s) 132 may use one or more models—such as one or more language models (and/or any other type of model)—to combine the audio text with the video text when generating the final text.

The method 900, at block B912, may include storing, in one or more databases, one or more embeddings associated with the third text. For instance, the storage component(s) 136 may process the final text data 134 to generate the embedding(s) associated with the final text. As described herein, in some examples, the storage component(s) 136 may initially segment the final text into one or more chunks of text. In some examples, the storage component(s) 136 may then associated with the chunk(s) of text with additional metadata. Additionally, the storage component(s) 136 may then encode the chunk(s) of text using one or more encoders to generate the embedding(s) for storage in the database(s) 138.

FIG. 10 illustrates a flow diagram showing a method 1000 for processing multimodal data to store information related to a video, in accordance with some embodiments of the present disclosure. The method 1000, at block B1002, may include generating, using one or more language models and based at least on audio data representing speech associated with a video, first text associated with a transcript corresponding to the speech. For instance, the language model(s) 128 may process the audio data 104 representing sound associated with the video, such as the speech from the video. Based at least on the processing, the language model(s) 128 may generate the audio text data 130 representing the audio text associated with the video. As described herein, the audio text may include at least a transcript associated with the speech from the video.

The method 1000, at block B1004, may include generating, using one or more vision language models and based at least on video data representing frames of the video, second text associated with a portion of the frames selected based at least on one or more criteria. For instance, the VLM(s) 124 may process the frame data 122 representing the frame(s) of the video to generate the video text data 126 representing the video text associated with the frame(s). As described herein, in some examples, the frame(s) may be selected based on one or more criteria. For instance, the video data 106 may be processed to identify one or more chapters within the video, one or more video clips associated with the chapter(s), and/or the frame(s) associated with the video clip(s).

The method 1000, at block B1006, may include generating third text associated with the video by at least combining the first text and the second text. For instance, the blending component(s) 132 may combine the audio text represented by the audio text data 130 with the video text represented by the video text data 126 to generate the final text associated with the video. As described herein, the blending component(s) 132 may use one or more techniques to combine the video text with the audio text. Additionally, by performing the processes described herein, the final text may describe both at least a portion of the audio of the video along with at least a portion of the content that is depicted by the video.

The method 1000, at block B1008, may include storing, in one or more databases, data associated with the third text. For instance, in some examples, the storage component(s) 136 may store data representing the final text in the database(s) 138. However, in some examples, the storage component(s) 136 may initially partition the final text into one or more chunks of text. The storage component(S) 136 may then encode the chunk(s) of text to generate one or more embeddings and store the embedding(s) in the database(s) 138. Still, in some examples, the storage component(s) 136 may generate and/or store additional information with regard to the final text, where the additional information may be represented by the metadata. For instance, the storage component(s) 136 may combine the additional information to the chunk(s) of text and then encode the chunk(s) of text with the additional information to generate the embedding(s) for storage in the database(s) 138.

### Example Language Models

In at least some embodiments, language models, such as small language models (SLMs), large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The SLMs/LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The SLMs/LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of SLMs/LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, SLMs/LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include SLMs/LLMs/VLMs/MMLMs/etc. may also include one or more diffusion block(s) (e.g., denoisers). The SLMs/LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. SLMs/LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the SLMs/LLMs/VLMs/MMLMs/etc.

In various embodiments, the SLMs/LLMs/VLMs/MMLMs/etc. may be trained using unsupervised learning, in which a SLMs/LLMs/VLMs/MMLMs/etc. learns patterns from large amounts of unlabeled text/audio/video/image/design/USD/etc. data. Due to the extensive training, in embodiments, the models may not require task-specific or domain-specific training. SLMs/LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some SLMs/LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the SLMs/LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the SLMs/LLMs/VLMs/MMLMs/etc., and/or preventing the output or presentation (e.g., display, audio output, etc.) of information generating using the SLMs/LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the SLMs/LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the SLMs/LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., SLMs/LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include a SLM, a LLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1130 (e.g., SLM/LLM/VLM/MMLM/etc.). In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some implementations in which the generative LM 1130 is capable of processing multi-modal inputs, the input 1101 may combine text (or may omit text) with image data, audio data, video data, design data, USD data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 (which may include one or more RAG models, and/or may be performed using the generative LM 1130 itself) may be used to retrieve additional information to be used as part of the input 1101 or prompt. RAG may be used to enhance the input to the SLM/LLM/VLM/MMLM/etc. with external knowledge, so that answers to specific questions or queries or requests are more relevant—such as in a case where specific knowledge is required. The RAG component 1192 may fetch this additional information (e.g., grounding information, such as grounding text/image/video/audio/USD/CAD/etc.) from one or more external sources, which can then be fed to the SLM/LLM/VLM/MMLM/etc. along with the prompt to improve accuracy of the responses or outputs of the model.

For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The RAG component 1192 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1192 and the embeddings of the chunks along with the embeddings of the query may be compared to identify the most similar/related embeddings to the query, which may be supplied to the generative LM 1130 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the SLM/LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the SLM/LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the SLM/LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the SLM/LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1192 may implement a plugin, API, user interface, and/or other functionality to perform RAG. For example, a graph RAG plug-in may be used by the SLM/LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1110 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1101 includes image data/video data/etc., the input processor 1101 may resize the data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some implementations in which the input 1101 includes audio data, the input processor 1101 may resample an audio file to a consistent sampling rate for uniform processing, and the embedding component 1120 may use any known technique to extract and encode audio features—such as in the form of a spectrogram (e.g., a mel-spectrogram). In some implementations in which the input 1101 includes video data, the input processor 1101 may extract frames or apply resizing to extracted frames, and the embedding component 1120 may extract features such as optical flow embeddings or video embeddings and/or may encode temporal information or sequences of frames. In some implementations in which the input 1101 includes multi-modal data, the embedding component 1120 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1130 and/or other components of the generative LM system 1100 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

FIG. 11B is a block diagram of an example implementation in which the generative LM 1130 includes a transformer encoder-decoder. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example implementation, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example implementation, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example implementation in which the generative LM 1130 includes a decoder-only transformer architecture. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this implementation). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: One or more processors comprising: processing circuitry to: generate, using one or more language models and based at least on audio data representing at least speech associated with a video, first text associated with a transcript corresponding to the speech; determine, based at least on video data representing frames of the video, one or more chapters associated with the video, one or more clips associated with the one or more chapters, and one or more frames associated with the one or more clips; generate, using one or more vision language models and based at least on the one or more frames, second text associated with the one or more frames; and store, in one or more databases, data associated with third text that includes at least a portion of the first text and at least a portion of the second text.

B: The one or more processors of paragraph A, wherein the one or more processors are in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more small language models (SLMs); a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

C: A method comprising: generating, using one or more language models and based at least on audio data representing at least speech associated with a video, first text associated with a transcript corresponding to the speech; determining, based at least on video data representing frames of the video, one or more sets of frames from the frames; determining, based at least on analyzing one or more visual attributes associated with individual frames from the one or more sets of frames, one or more frames from the one or more sets of frames; generating, using one or more vision language models and based at least on the one or more frames, second text associated with the one or more frames; generating third text associated with the video by at least combining the first text and the second text; and storing, in one or more databases, one or more embeddings associated with the third text.

D: The method of paragraph C, wherein the determining the one or more sets of frames from the frames comprises: determining, based at least on the video data, one or more visual differences between one or more consecutive frames from the frames; determining, based at least on the one or more visual differences, one or more scene transitions within the video; and determining the one or more sets of frames based at least on the one or more scene transitions.

E: The method of either paragraph C or paragraph D, wherein the determining the one or more sets of frames from the frames comprises: determining, based at least on the video data, similarity scores indicating visual similarities between consecutive frames from the frames; determining one or more threshold scores based at least on the similarity scores; determining that a portion of the similarity scores satisfies the one or more threshold scores; and determining the one or more sets of frames based at least on the portion of the similarity scores.

F: The method of any one of paragraphs C-E, wherein the determining the one or more frames from the one or more sets of frames comprises: determining, based at least on the one or more visual attributes associated with the individual frames from the one or more sets of frames, entropy values associated with the individual frames; determining that a portion of the entropy values satisfies a threshold value; and determining the one or more frames as being associated with the portion of the entropy values.

G: The method of any one of paragraphs C-F, wherein the generating the third text comprises: determining one or more first timestamps associated with the first text; determining one or more second timestamps associated with the second text; and generating, based at least on the one or more first timestamps and the one or more second timestamps, the third text by at least inputting one or more portions of the second text into one or more portions of the first text.

H: The method of any one of paragraphs C-G, wherein the generating the third text comprises: determining that one or more first portions of the first text are associated with the one or more sets of frames; determining that one or more second portions of the second text are associated with the one or more sets of frames; and generating the third text by at least combining the one or more first portions of the first text with the one or more second portions of the second text.

I: The method of any one of paragraphs C-H, further comprising: determining, based at least on downsampling the video data, a portion of the frames of the video, wherein the determining the one or more sets of frames is based at least on updated video data representing the portion of the frames.

J: The method of any one of paragraphs C-I, further comprising: determining one or more chunks of text that are associated with the third text; and generating, using one or more encoders, the one or more embeddings associated with the one or more chunks of text.

K: The method of any one of paragraphs C-J, further comprising: receiving input data representing a query associated with the video; generating, based at least on the input data, one or more second embeddings associated with the query; determining, based at least on the one or more embeddings stored in the one or more databases and the one or more second embeddings, information associated with the video that is related to the query; and generating, based at least on the query and the information, a response associated with the query.

L: A system comprising: one or more processors to: generate, using one or more language models and based at least on audio data representing at least speech associated with a video, first text associated with a transcript corresponding to the speech; determine, based at least on video data representing frames of the video, one or more sets of frames from the frames; selecting, based at least on the one or more sets of frames, one or more frames from the one or more sets of frames; generate, using one or more vision language models and based at least on the one or more frames, second text associated with the one or more frames; and store, in one or more databases, data representing at least the first text associated with the transcript and the second text associated with the one or more frames.

M: The system of paragraph L, wherein the determination of the one or more sets of frames from the frames comprises: determining, based at least on the video data, one or more visual differences between one or more consecutive frames from the frames; determining, based at least on the one or more visual differences, one or more scene transitions within the video; and determining the one or more sets of frames based at least on the one or more scene transitions.

N: The system of either paragraph L or paragraph M, wherein the determination of the one or more sets of frames from the frames comprises: determining, based at least on the video data, similarity scores indicating visual similarities between consecutive frames from the frames; determining one or more threshold scores based at least on the similarity scores; determining that a portion of the similarity scores satisfies the one or more threshold scores; and determining the one or more sets of frames based at least on the portion of the similarity scores.

O: The system of any one of paragraphs L-N, wherein the determination of the one or more sets of frames from the frames comprises: determining, based at least on the video data, one or more chapters associated with the video; and determining, based at least on the one or more chapters, one or more clips within the one or more chapters, wherein the one or more sets of frames correspond to the one or more clips.

P: The system of any one of paragraphs L-O, wherein the selection of the one or more frames from the one or more sets of frames comprises: determining, based at least on one or more visual attributes associated with individual frames from the one or more sets of frames, entropy values associated with the individual frames; determining that a portion of the entropy values satisfies a threshold value; and selecting the one or more frames as being associated with the portion of the entropy values.

Q: The system of any one of paragraphs L-P, wherein the selection of the one or more frames from the one or more sets of frames comprises at least one of: selecting one or more starting frames from the one or more sets of frames; or selecting one or more ending frames from the one or more set of frames.

R: The system of any one of paragraphs L-Q, wherein the one or more processors are further to: generate third text by combining at least a portion of the first text with at least a portion of the second text, wherein the data represents one or more portions of the third text.

S: The system of any one of paragraphs L-R, wherein the one or more processors are further to: determine, based at least on downsampling the video data, a portion of the frames of the video, wherein the one or more sets of frames are determined based at least on the portion of the frames.

T: The system of any one of paragraphs L-S, wherein the system is in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more small language models (SLMs); a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
generating, using one or more language models and based at least on audio data representing at least speech associated with a video, first text associated with a transcript corresponding to the speech;
determining, based at least on video data representing frames of the video, one or more sets of frames from the frames;
determining, based at least on analyzing one or more visual attributes associated with individual frames from the one or more sets of frames, one or more frames from the one or more sets of frames;
generating, using one or more vision language models and based at least on the one or more frames, second text associated with the one or more frames;
generating third text associated with the video by at least combining the first text and the second text; and
storing, in one or more databases, one or more embeddings associated with the third text.

2. The method of claim 1, wherein the determining the one or more sets of frames from the frames comprises:
determining, based at least on the video data, one or more visual differences between one or more consecutive frames from the frames;
determining, based at least on the one or more visual differences, one or more scene transitions within the video; and
determining the one or more sets of frames based at least on the one or more scene transitions.

3. The method of claim 1, wherein the determining the one or more sets of frames from the frames comprises:
determining, based at least on the video data, similarity scores indicating visual similarities between consecutive frames from the frames;
determining one or more threshold scores based at least on the similarity scores;
determining that a portion of the similarity scores satisfies the one or more threshold scores; and
determining the one or more sets of frames based at least on the portion of the similarity scores.

4. The method of claim 1, wherein the determining the one or more frames from the one or more sets of frames comprises:
determining, based at least on the one or more visual attributes associated with the individual frames from the one or more sets of frames, entropy values associated with the individual frames;
determining that a portion of the entropy values satisfies a threshold value; and
determining the one or more frames as being associated with the portion of the entropy values.

5. The method of claim 1, wherein the generating the third text comprises:
determining one or more first timestamps associated with the first text;
determining one or more second timestamps associated with the second text; and
generating, based at least on the one or more first timestamps and the one or more second timestamps, the third text by at least inputting one or more portions of the second text into one or more portions of the first text.

6. The method of claim 1, wherein the generating the third text comprises:
determining that one or more first portions of the first text are associated with the one or more sets of frames;
determining that one or more second portions of the second text are associated with the one or more sets of frames; and
generating the third text by at least combining the one or more first portions of the first text with the one or more second portions of the second text.

7. The method of claim 1, further comprising:
determining, based at least on downsampling the video data, a portion of the frames of the video,
wherein the determining the one or more sets of frames is based at least on updated video data representing the portion of the frames.

8. The method of claim 1, further comprising:
determining one or more chunks of text that are associated with the third text; and
generating, using one or more encoders, the one or more embeddings associated with the one or more chunks of text.

9. The method of claim 1, further comprising:
receiving input data representing a query associated with the video;
generating, based at least on the input data, one or more second embeddings associated with the query;
determining, based at least on the one or more embeddings stored in the one or more databases and the one or more second embeddings, information associated with the video that is related to the query; and
generating, based at least on the query and the information, a response associated with the query.

10. A system comprising:
one or more processors to:
generate, using one or more language models and based at least on audio data representing at least speech associated with a video, first text associated with a transcript corresponding to the speech;
determine, based at least on video data representing frames of the video, one or more sets of frames from the frames;
selecting, based at least on the one or more sets of frames, one or more frames from the one or more sets of frames;
generate, using one or more vision language models and based at least on the one or more frames, second text associated with the one or more frames; and
store, in one or more databases, data representing at least the first text associated with the transcript and the second text associated with the one or more frames.

11. The system of claim 10, wherein the determination of the one or more sets of frames from the frames comprises:
determining, based at least on the video data, one or more visual differences between one or more consecutive frames from the frames;
determining, based at least on the one or more visual differences, one or more scene transitions within the video; and
determining the one or more sets of frames based at least on the one or more scene transitions.

12. The system of claim 10, wherein the determination of the one or more sets of frames from the frames comprises:
determining, based at least on the video data, similarity scores indicating visual similarities between consecutive frames from the frames;
determining one or more threshold scores based at least on the similarity scores;
determining that a portion of the similarity scores satisfies the one or more threshold scores; and
determining the one or more sets of frames based at least on the portion of the similarity scores.

13. The system of claim 10, wherein the determination of the one or more sets of frames from the frames comprises:
determining, based at least on the video data, one or more chapters associated with the video; and
determining, based at least on the one or more chapters, one or more clips within the one or more chapters, wherein the one or more sets of frames correspond to the one or more clips.

14. The system of claim 10, wherein the selection of the one or more frames from the one or more sets of frames comprises:
determining, based at least on one or more visual attributes associated with individual frames from the one or more sets of frames, entropy values associated with the individual frames;
determining that a portion of the entropy values satisfies a threshold value; and
selecting the one or more frames as being associated with the portion of the entropy values.

15. The system of claim 10, wherein the selection of the one or more frames from the one or more sets of frames comprises at least one of:
selecting one or more starting frames from the one or more sets of frames; or
selecting one or more ending frames from the one or more set of frames.

16. The system of claim 10, wherein the one or more processors are further to:
generate third text by combining at least a portion of the first text with at least a portion of the second text,
wherein the data represents one or more portions of the third text.

17. The system of claim 10, wherein the one or more processors are further to:
determine, based at least on downsampling the video data, a portion of the frames of the video,
wherein the one or more sets of frames are determined based at least on the portion of the frames.

18. The system of claim 10, wherein the system is in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more small language models (SLMs);
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. One or more processors comprising:
processing circuitry to:
generate, using one or more language models and based at least on audio data representing at least speech associated with a video, first text associated with a transcript corresponding to the speech;
determine, based at least on video data representing frames of the video, one or more chapters associated with the video, one or more clips associated with the one or more chapters, and one or more frames associated with the one or more clips;
generate, using one or more vision language models and based at least on the one or more frames, second text associated with the one or more frames; and
store, in one or more databases, data associated with third text that includes at least a portion of the first text and at least a portion of the second text.

20. The one or more processors of claim 19, wherein the one or more processors are in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more small language models (SLMs);
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
